(19) United States
(12) Patent Application Publication
(10) Pub. No.: US 2006/0051190 A1
(43) Pub. Date: Mar. 9, 2006

(54) Article storage system

(76) Inventor: Kazuhiro Taguchi, Komaki-shi (JP)

Correspondence Address: D. PETER HOCHBERG CO. L.P.A., 1940 EAST 6TH STREET, CLEVELAND, OH, 44114, US

(21) Appl. No.: 10/936,382

(22) Filed: Sep. 8, 2004

(51) Int. Cl. B65G 1/00

(52) U.S. Cl. 414/279

(57) ABSTRACT

An article storage system includes a crane controller for performing conveyance of an article between an article accommodating section and a carry in/out port by controlling a stacker crane, and a communication controller for performing communication of control information executed by a driving device from at least the crane controller between the driving device and the crane controller. The crane controller on the ground side and the driving device, such as lift driving device, travel driving device and fork device, of the stacker crane are connected by the communication controller. The driving device is controlled by the control information from the crane controller to drive the stacker crane and perform take in/out of the article.

### BACKGROUND OF THE INVENTION

1. Field of the Invention

The present invention relates to an article storage system such as an automatic warehouse.

2. Description of the Related Art

A conventional type of article storage system includes an article storage system of the following configuration.

The above article storage system includes a plurality of article accommodating sections for accommodating articles, and an article conveying apparatus for conveying the articles between the article accommodating section and a predetermined carry in/out port, and is configured so that the articles are taken in or taken out at the carry in/out port. That is, the article storage system comprises an accommodating rack as the article accommodating section, and a stacker crane including a travel vehicle, a lifting platform and a fork device as components of the article conveying apparatus, and a main-body controller for controlling the drive of the travel vehicle, the lifting platform and the fork device.

The accommodating rack has a plurality of partitioned accommodating spaces (article accommodating section) which are arranged in parallel and in multilevels in order for accommodating the articles.

The travel vehicle travels along the accommodating rack.

The lifting platform is lifted and lowered along a mast installed vertically on the travel vehicle.

The fork device is provided on the lifting platform, and the articles are transferred by extending/retracting the fork device at the article accommodating section (partitioned accommodating space of the accommodating rack) and the carry in/out port.

A distance measuring instrument for measuring a traveled distance of the travel vehicle from the carry in/out port and a distance measuring instrument for measuring a lifted/lowered distance of the lifting platform from the travel vehicle are provided on the stacker crane.

The traveled distance and the lifted/lowered distance measured by each distance measuring instrument are input to the main-body controller, which controller then controls the positions of the travel vehicle and the lifting platform while feeding back the traveled distance and the lifted/lowered distance.

A ground side controller is provided on the ground side in order for transmitting, to the main-body controller on the stacker crane, a command signal for specifying for example an article accommodating section at which the stacker crane transfers articles. The traveling body, the lifting platform, and the fork device are driven by the main-body controller on the stacker crane by transmitting the command signal from the ground side controller to the main-body controller on the stacker crane. Such operation of the stacker crane enables it to perform storing/retrieving of articles between the carry in/out port and the article accommodating section, and transfer of articles between one article accommodating section and another article accommodating section in the accommodating rack. Data on a detector on the stacker crane, for example, is transferred to the ground side controller from the main-body controller on the stacker crane, and the state of the stacker crane is monitored at the ground side controller.

In the foregoing conventional article storage system, since the main-body controller is provided on the stacker crane, it is necessary that the main-body controller has some prevention measures against vibration and noise generated while the stacker crane conveys articles. Further, since an operator needs to enter a passage where the stacker crane is running in order to adjust the main-body controller, special attention should be paid to the safety of the operator. Furthermore, since a controller is necessary on both the ground side and the stacker crane side, high costs are required for installation of the system.

### SUMMARY OF THE INVENTION

It is an object of the present invention to provide an article storage system in which a controller needs no countermeasure against vibration and noise generated during article conveyance by a stacker crane, operations by maintenance workers inside a passage can be reduced, and cost reduction is achieved.

The present invention is directed to an article storage system including a plurality of article accommodating sections for accommodating an article and an article conveying apparatus for conveying the article between the article accommodating section and a predetermined carry in/out port, which article conveying apparatus includes a driving device to perform conveyance of the article. The system further includes a conveyance controller for conveying the article between the article accommodating section and the carry in/out port by directly controlling the driving device of the article conveying apparatus, and a communication device for communicating at least control information executed by the driving device from the conveyance controller, between the driving device and the conveyance controller. The conveyance controller on the ground side and the driving device of the article conveying apparatus are connected by a communication controller, and the driving device is controlled by the control information from the conveyance controller, so that the article conveying apparatus is driven to perform take in/out of the article.

### BRIEF DESCRIPTION OF THE DRAWINGS

FIG. 1 a configuration diagram illustrating how to control an article storage system according to a preferred embodiment of the present invention;

FIG. 2 is a perspective view of the article storage system; and

FIG. 3 is a diagram illustrating a data flow for the article storage system.

### DESCRIPTION OF THE PREFERRED EMBODIMENTS

Preferred embodiment of the present invention will now be described based on the accompanying drawings.

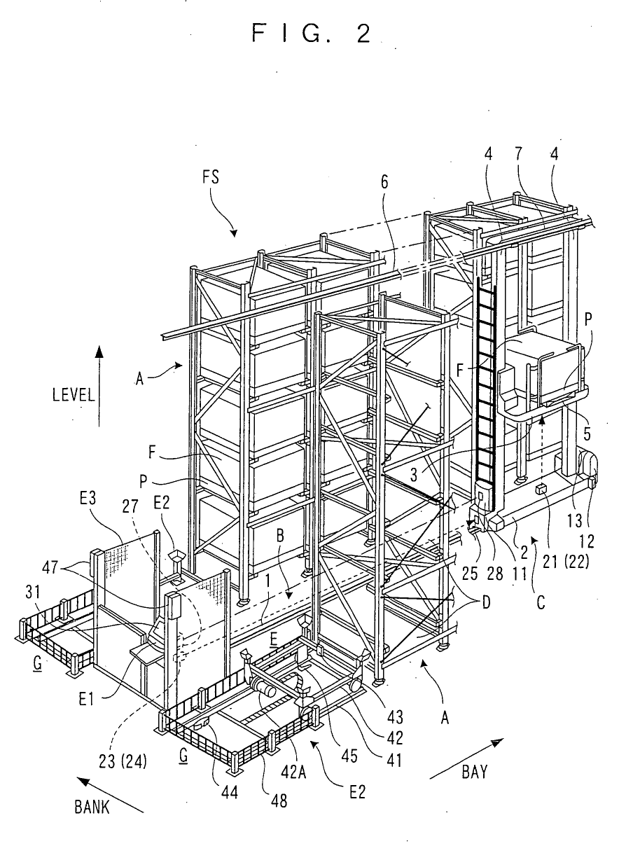

FIG. 2 is a schematic perspective view of an article storage system according to the preferred embodiment of the present invention.

As shown in FIG. 2, the article storage system FS includes two accommodating racks A arranged with a space therebetween so that directions of taking in and taking out of the article are opposed to each other, and a stacker crane C (one example of an article conveying apparatus) automatically traveling on a work passage B formed between the accommodating racks A. In each accommodating rack A, a plurality of article accommodating sections D are arranged in parallel and in multilevels.

A traveling rail 1 of the stacker crane C is arranged in the longitudinal direction of the accommodating rack A in the work passage B. A crane controller E1 (one example of a conveyance controller) for controlling the stacker crane C, a pair of disposal device E2 (one example of article receiving device and carry in/out port of article) sandwiching the traveling rail 1, and a safety fence E3 for prohibiting the workers from entering the work passage B are arranged at the carry in/out port E for the article F of the stacker crane C arranged at one end of the work passage B. The stacker crane C runs along the traveling rail 1 when the drive of a driving device (to be hereinafter described in detail) is implemented by the crane controller E1, and is configured to serve as the storing/retrieving article conveying apparatus for taking in and taking out the article F loaded on a pallet P between the disposal device E2 arranged at the carry in/out port E and the article accommodating section D.

The stacker crane C is configured by a travel vehicle 2 traveling along the traveling rail 1, a lifting platform (carriage) 3, and a front-back pair of lifting mast 4 for guiding and supporting the lifting platform 3 in a freely lift operating manner. A fork device (article transferring device) 5 for transferring articles is provided on the lifting platform 3. A guide rail 6 is constructed along the traveling rail 1 at the roof part of the article storage system FS. At the upper ends of the pair of lifting mast 4, an upper frame 7, coupling the above upper ends and sandwiching the guide rail 6 from the right and left, for regulating the upper position of the stacker crane C with the traveling of the stacker crane C is provided. A main-body driving board 11 is provided on the travel vehicle 2 at a position facing the crane controller E1 external to the lifting mast 4. Further, a lift driving device 12 for lifting and lowering the lifting platform 3 and a travel driving device 13 for traveling the travel vehicle 2 are provided at a position opposite the main-body driving board 11 external to the lifting mast 4. A manual operating device (not shown) for manually operating the stacker crane C is connectable to the main-body driving board 11.

A first distance measuring device (one example of lifted/lowered position detection device) 21 for detecting the lifted/lowered position of the lifting platform 3 is provided on the travel vehicle 2. The first distance measuring device 21 is configured by a first laser distance measuring instrument 22 for projecting a beam light for vertical distance measurement and measuring the distance by the reflected light, and a first reflecting body (mirror, not shown), arranged at a lower face of the lifting platform 3, for reflecting the beam light projected from the first laser distance measuring instrument 22.

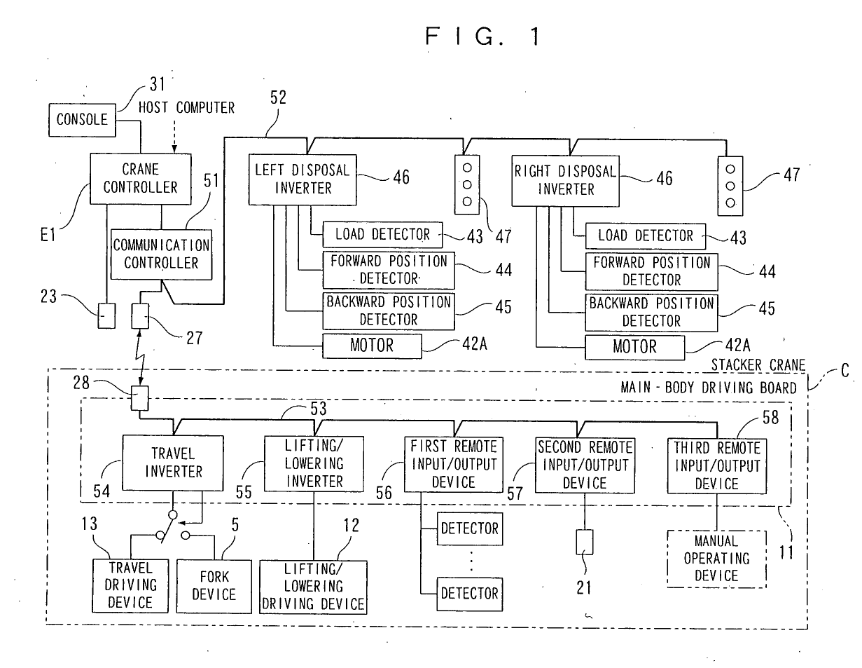

A second distance measuring device (one example of a travel position detection device) 23 for detecting the travel position of the travel vehicle 2 is arranged at the carry in/out port E. The second distance measuring device 23 is configured by including a second laser distance measuring instrument 24 for projecting the beam light for horizontal distance measurement in a traveling direction of the travel vehicle 2 and measuring the distance by the reflected light, and a second reflecting body (mirror) 25, arranged at a front face (carry in/out port position E side) of the traveling device 2 of the stacker crane C so as to face the projected light of the second laser distance measuring instrument 24. The travel position detected information of the travel vehicle 2 by the second distance measuring device 23 is input to the crane controller El, as shown in FIG. 1.

Further, a first optical transmission device 27 connected to the crane controller E1 is arranged at the carry in/out port E so as to face the stacker crane C, and a second optical transmission device 28 is arranged at a front face of the main-body driving board 11 of the stacker crane C so as to face the first optical transmission device 27.

A console 31 of the crane is arranged at the surface of the crane controller El, and is connected to the crane controller El, as shown in FIG. 1. A selector switch for selecting an operation mode such as, on-line mode and remote mode, a selector switch for selecting a work mode such as, storing mode and retrieving mode, and a state displaying part for displaying the operating state and errors of the stacker crane C are provided in the console 31. The on-line mode is a mode for controlling the stacker crane C by the crane controller E1 in response to a command from the host computer, and the remote mode is a mode for controlling the stacker crane C by a setting from the console 31.

As shown in FIGS. 1 and 2, each disposal device E2 is configured by a pair of traveling rail 41, a self-propelled cart 42, a load detector 43, a forward position detector 44, a backward position detector 45, a disposal inverter equipped with communicating function 46, an operation box equipped with communicating function 47, and a safety fence 48.

The pair of traveling rail 41 is constructed across the carry in/out port E and a storing and delivery position G by a cargo-handling device (e.g., forklift).

The self-propelled cart 42 travels along the traveling rail 41.

The load detector 43 is formed by a photoelectric switch, and detects the loading of the article F on the self-propelled cart 42.

The forward position detector 44 is formed by a limit switch and detects the presence of the self-propelled cart 42 at the forward position (storing and delivery position G).

The backward position detector 45 is formed by a limit switch and detects the presence of the self-propelled cart 42 at the backward position (carry in/out port position E).

The disposal inverter 46 equipped with communicating function moves the self-propelled cart 42 forward or backward by controlling the electric supply to a motor 42A of the self-propelled cart 42. Further, the load detector 43, the forward position detector 44, and the backward position detector 45 are connected to the disposal inverter 46, as shown in FIG. 1.

The operation box equipped with communicating function 47 is attached to a side face of the safety fence E3 and performs the setting of the disposal device E2. Further, a mode selector switch for selecting automatic mode/manual mode, a manual operating switch for selecting a storing position (forward position) to move the self-propelled cart 42 to the storing and delivery position G and a retrieving position (backward position) to move the self-propelled cart 42 to the carry in/out position E during manual mode, an operating lamp and the like are provided in the operation box equipped with communicating function 47.

The safety fence 48 prevents the workers from entering the traveling rail 41.

As shown in FIG. 1, a (master) communication controller.51 is connected to the crane controller E1. The disposal inverter 46 and the operation box 47 of each disposal device E2 and the first optical transmission device 27 are connected to the communication controller 51 by way of a field bus 52. Further, a travel inverter equipped with communicating function 54, a lifting/lowering inverter equipped with communicating function 55, a first remote input/output device (one example of remote input/output device) equipped with communicating function 56, a second remote input/output device equipped with communicating function 57, and a third remote input/output device equipped with communicating function 58 are connected, as the driving devices, to the communication controller 51 by way of the first optical transmission device 27, the second optical transmission device 28, and a field bus 53.

The travel inverter equipped with communicating function 54 switches and connects the travel driving device 13 and the fork device 5. The output of the travel inverter 54 is switched by another output of the travel inverter 54 and is input to either the travel driving device 13 or the fork device 5.

The lifting/lowering inverter equipped with communicating function 55 is connected to the lift driving device 12.

The first remote input/output device equipped with communicating function 56 is connected to the detector such as a limit switch for detecting the state (upper limit position or lower limit position) of the lifting platform 3.

The second remote input/output device equipped with communicating function 57 is connected to the first distance measuring device 21.

The third remote input/output device equipped with communicating function 58 is connected to the manual operating device.

The field bus 53, the travel inverter equipped with communicating function 54, the lifting/lowering inverter equipped with communicating function 55, the first remote input/output device equipped with communicating function 56, the second remote input/output device equipped with communicating function 57, and the third remote input/output device equipped with communicating function 58 are housed in the main-body driving board 11.

The communicating function of each device and inverter is effected by a communication controller 51, and a communication device is configured by including the communication controller 51, the field buses 52 and 53, and the optical transmission devices 27 and 28. Each device and inverter including the communication controller 51 each forms a so-called device net.

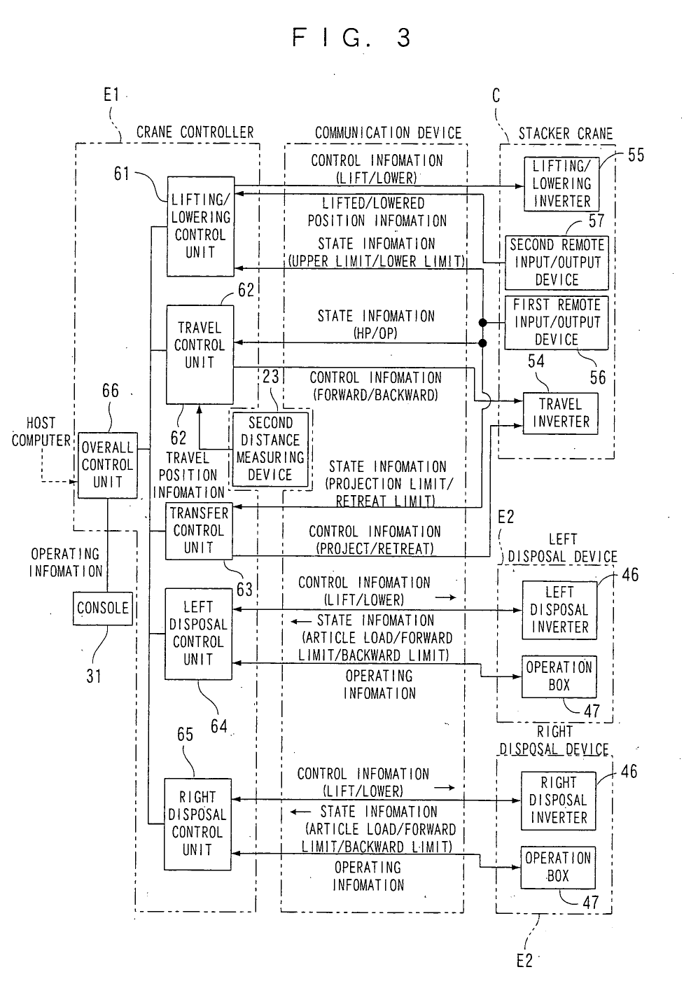

As shown in FIG. 3, the crane controller E1 is configured by a lift control unit 61, a travel control unit 62, a transfer control unit 63, a left disposal control unit 64, a right disposal control unit 65, and an overall control unit 66. The travel inverter 54 and the lifting/lowering inverter 55 of the stacker crane C are controlled and driven by the crane controller E1 to convey the article F between the carry in/out port E and the article accommodating section D and to transfer the article F with the article accommodating section D or the disposal device E2, and the left and right disposal devices E2 are controlled by the crane controller E1 to carry in/out the article F.

The overall control unit 66 of the crane controller E1 is connected to the console 31, and controls each control units 61 to 65, and generates target command data for each control units 61 to 65 based on the setting data input from the host computer or the console 31 that is, work mode (modes such as, storing/retrieving and picking), the position (data of bank, bay, level of the accommodating rack A) of the article accommodating section D where storing/retrieving is carried out, and (right or left) of the disposal device E2 for performing carry in/out.

Lifted/lowered position information detected in the second laser distance measuring device 23, and state information (e.g., positional information such as upper limit position and lower limit position at which the lifting platform 3 is positioned) of the lifting platform 3 input to the first remote input/output device 56 are input to (received by) the lift control unit 61 via the field bus 53, the second optical transmission device 28, the first optical transmission device 27, the field bus 52, and the communication controller 51 from the second remote input/output device 57 and the first remote input/output device 56, respectively. After the target command data (data of level of the lifting platform) is input by the overall control unit 66, the lift control unit 61 outputs the control information (lift command data, lower command data) to the lifting/lowering inverter 55 via the communication controller 51, the field bus 52, the first optical transmission device 27, the second optical transmission device 28, and the field bus 53 while feeding back and monitoring the state information and the lifted/lowered position information of the lifting platform 3. The lift driving device 12 is thereby drive controlled to lift or lower the lifting platform 3 to the specified lift position.

The travel position information detected in the first laser distance measuring device 21 is input to the travel control unit 62, and further, the state information (e.g., positional information such as carry in/out port position HP, end position OP at which the travel vehicle 2 is positioned) of the travel vehicle 2 is input to (received by) the travel control unit 62 from the first remote input/output device 56 via the field bus 53, the second optical transmission device 28, the first optical transmission device 27, the field bus 52 and the communication controller 51. After the travel command data (data of position of disposal device E2 or of bay of article accommodating section D) is input by the overall control unit 66, the travel control unit 62 outputs the control information (forward command data, backward command data) to the travel inverter 54 via the communication controller 51, the field bus 52, the first optical transmission device 27, the second optical transmission device 28, and the field bus 53 while feeding back and monitoring the state information and the travel position information of the travel vehicle 2. The travel driving device 13 is thereby drive controlled to travel the travel vehicle 2 to the specified travel position.

The state information of the fork device 5 (positional information such as, projection and retreat state of fork) is input to (received by) the transfer control unit 63 from the first remote input/output device 56 via the field bus 53, the second optical transmission device 28, the first optical transmission device 27, the field bus 52, and the communication controller 51. After the data indicating that control to the target position is finished is input by the lift control unit 61 and the travel control unit 62, the transfer control unit 63, based on the target command data (data of disposal device E2 position and bank of article accommodating section D) input from the overall control unit 66, monitors the state information of the travel vehicle 2 while outputting the control information (left projection command data, retreat command data onto the lifting platform 3, and right projection command data, each for fork) to the common travel inverter 54 via the communication controller 51, the field bus 52, the first optical transmission device 27, the second optical transmission device 28, and the field bus 53. The travel driving device 13 is thereby drive controlled to project or exit/enter the fork device 5 to the specified position.

The detected signals of the load detector 43, the forward position detector 44 and the backward position detector 45 are input to (received by) the left disposal control unit 64 from the disposal inverter 46 via the field bus 52 and the communication controller 51. After the target command data (storing mode or retrieving mode) is input by the overall control unit 66, the left disposal control unit 64 checks the operating information input by the operation box 47 and controls the disposal inverter 46 of the disposal device E2 on the left and moves the self-propelled cart 42 to a specified position through the communication controller 51 and the field bus 52 while monitoring the detected signal.

The right disposal control unit 65 carries out the operation similar to that of the left disposal control unit 64.

The operations by the above configuration will now be explained taking, by way of example, the work mode as the storing mode.

With regards to the setting mode input by the console 31, the work mode is the storing mode, the data of the article accommodating section D for storing the article F is (bank “2”, bay “5” and level “3”), and the disposal device E2 for performing the carry in/out is “left”.

First, the overall control unit 66 outputs a store command to the left disposal control unit 64, outputs a travel command to the disposal device E2 position to the travel control unit 62, outputs a lift command to the disposal device E2 position to the lift control unit 61, and outputs take in/out command to the left to the transfer control unit 63.

The left disposal control unit 64, in response to the store command from the overall control unit 66, transmits the control information to the left disposal inverter 46 via the field bus 52 and the communication controller 51, moves the self-propelled cart 42 forward and stops the self-propelled cart 42 when the detected signal of the forward position detector 44 is turned ON. Further, when the detected signal of the load detector 43 is turned ON (article F is loaded), and the automatic mode is set by the operation box 47, the left disposal control unit 64 moves the self-propelled cart 42 backward and stops the self-propelled cart 42 when the detected signal of the backward position detector 45 is turned ON, and outputs a signal informing the arrival of the article F to the transfer control unit 63.

The travel control unit 62, in response to the travel command to the disposal device E2 position, outputs the control information (forward command data) to the travel inverter 54 via the communication controller 51, the field bus 52, the first optical transmission device 27, the second optical transmission device 28, and the field bus 53, and travels the travel vehicle 2 to the disposal device E2 position. When the travel vehicle 2 arrives at the disposal device E2 position, the travel control unit 62 then outputs a signal informing the arrival of the travel vehicle 2 to the transfer control unit 63.

The lift control unit 61, in response to the lift command to the disposal device E2 position, outputs the control information (lower command data) to the lifting/lowering inverter 55 via the communication controller 51, the field bus 52, the first optical transmission device 27, the second optical transmission device 28, and the field bus 53, and lowers the lifting platform 3 to an unloading position under the pallet of the disposal device E2 position. Further, when lifting/lowering of the lifting platform 3 is finished, the lift control unit 61 outputs a signal informing the arrival to the unloading position of the lifting platform 3 to the transfer control unit 63.

After the take in/out command to the left is input, the signal informing the arrival of the article F is input by the left disposal control unit 64, the signal informing the arrival of the travel vehicle 2 is input by the travel control unit 62, and the signal informing the arrival to the unloading position of the lifting platform 3 is input by the lift control unit 61, the transfer control unit 63 outputs the control information (project command data to the left of the fork) to the travel inverter 54 via the communication controller 51, the field bus 52, the first optical transmission device 27, the second optical transmission device 28 and the field bus 53, projects the fork to the unloading position under the pallet P and outputs the projection finish signal to the lift control unit 61.

After the projection finish signal is input, the lift control unit 61 outputs the control information (lift command data) to the lifting/lowering inverter 55 via the communication controller 51, the field bus 52, the first optical transmission device 27, the second optical transmission device 28 and the field bus 53, and lifts the lifting platform 3 to a scoop position of the disposal device E2. When lifting/lowering of the lifting platform 3 is finished, the lift control unit 61 outputs a signal informing the arrival to the scoop position of the lifting platform 3 to the transfer control unit 63. The pallet P is thereby scooped by the fork.

After the signal informing the arrival to the scoop position of the lifting platform 3 is input, the transfer control unit 63 outputs the control information (fork retreat command data) to the travel inverter 54 via the communication controller 51, the field bus 52, the first optical transmission device 27, the second optical transmission device 28, and the field bus 53, thereby to retreat the fork (load the palette P onto the lifting platform 3) and output an retreat finish signal to the overall control unit 66.

After the retreat finish signal is input, the overall control unit 66 outputs a travel command to the bay “5” position to the travel control unit 62, a lift command to the level “3” position to the lift control unit 61, and a take in/out command to the bank “2” (left) to the transfer control unit 63.

Based on such commands, with similar operations of each control unit 61, 62 and 63, the travel vehicle 2 is traveled to the bay “5” position, the lifting platform 3 is lifted to the scoop position of the level “3” position, the fork device 5 is projected to the bank “2” (left), and subsequently, the lifting platform 3 is lowered to the unloading position of the level “3” position and the fork device 5 is entered/exited, thereby storing the article F to the article accommodating section D of (bank “2”, bay “5”, level “3”).

With each control unit 61 to 66 of the crane controller E1, the control information is output directly to each inverter 46, 54 and 55, and the stacker crane C and the disposal device E2 are driven thus performing storing/retrieving of the article F.

Similar to the above mentioned storing mode, in other work modes as well, with each control unit 61 to 66 of the crane controller E1, the control information is output directly to each inverter 46, 54 and 55, and the stacker crane C and the disposal device E2 are driven thus performing storing/retrieving of the article F.

According to the above embodiment, the crane controller E1 on the ground side and each inverter 54, 55 of the stacker crane C are directly connected by the communication device (communication controller 51, the field bus 52, the first optical transmission device 27, the second optical transmission device 28 and the field bus 53) to form a network, and each inverter 54, 55 is controlled by the control information from the crane controller E1. That is, since the control information is transmitted to each device equipped with communicating function via the communication device by the controller on the ground side (crane controller E1) to carry out the taking in/out of the article F without providing a controller on the article conveying apparatus (stacker crane C) side, the main-body controller is not needed on the stacker crane C as in the conventional art. Therefore, the environment of the controller is improved, that is, a measure for vibration and noise generated during article conveyance of the stacker crane C is not needed in the controller.

The number of times the workers enter and work in the work passage B to carry out maintenance of the main-body controller on the stacker crane C is reduced.

By transmitting the control information to each device provided with communicating function by the controller on the ground side (crane controller E1) via the communication device without providing the controller on the article conveying apparatus (stacker crane C) side, the main-body controller becomes unnecessary on the article conveying apparatus (e.g., stacker crane) as in the conventional art and thus the cost reduction can be achieved.

According to the present embodiment, the crane controller E1 on the ground side and the remote input/output devices 56, 57, 58 of the stacker crane C are directly connected by the communication device, and transmission and reception of input/output information are carried out between the crane controller E1 and the remote input/output devices 56, 57, 58 of the stacker crane C, and thus the main-body controller for carrying out transmission/reception is unneeded on the stacker crane C as in the conventional art.

According to the present embodiment, by arranging the second laser distance measuring instrument 24 of the second distance measuring device 23 on the ground side, the information to be input via the communication device is reduced, the load of the communication device is reduced and thus high-speed communication can be achieved.

In the present embodiment, the optical transmission devices 27, 28 are used as a space communication device between the crane controller E1 on the ground side and the stacker crane C, but are not limited to the optical transmission device and communication may be performed using a radio wave.

In the present embodiment, the travel inverter 54 is used for the travel driving device 13 and also for the fork device 5, but an inverter may be provided for each the travel driving device 13 and the fork device 5.

In the present embodiment, each accommodating rack A arranged adjacent to each other in the horizontal direction is configured so as to have the article accommodating section D in the front-back direction, but each accommodating rack A may be configured so that the article accommodating section D is arranged not only in the front-back direction but also in the horizontal direction (depth direction). Here, the fork device 5 has a configuration (double-deep type) in which the fork (take in/out tool) is positioned and exited with respect to each article accommodating section D in the horizontal direction of each accommodating rack A.

Additionally, in the present embodiment, a pair of disposal device E2 of the carry in/out port E is used as a carry in/out port to perform carry in/out of the article F, but the disposal device E2 may be used as a dedicated carry in port or a dedicated carry out port of the article F. Further, the self-propelled cart is used as the disposal device E2, but a fixed article receiving plate, a product receiving plate with a lifter, a conveyor and the like may also be used.

In the present embodiment, a rack facility (automatic warehouse) using the stacker crane C is given as an example of the article storage system, but may also be an article storage system not equipped with a configuration corresponding to the travel vehicle 2 of the stacker crane C. Such system is for example, a three-dimensional picking system including a accommodating rack A, a lifting platform 3 lifted in the vertical direction across substantially the entire range of the vertical height of the accommodating rack A, and a fork device 5, arranged on the lifting platform 3 in a freely laterally moving manner, for transferring the article F to the article accommodating section D of the accommodating rack A or the carry in/out port E.

In the present embodiment, the stacker crane C is used as the article conveying apparatus of the article storage system, but the article conveying apparatus may not be equipped with a configuration corresponding to the lifting platform 3 and the lifting mast 4 of the stacker crane C. Such article conveying apparatus includes a self-propelled conveying cart, installed with a transfer device such as, a roller conveyor, for loading and conveying the article on the transfer device.

What is claimed is:

1. An article storage system comprising a plurality of article accommodating sections for accommodating an article and an article conveying apparatus for conveying the article between the article accommodating section and a predetermined carry in/out port, the article conveying apparatus including a driving device for performing conveyance of the article, the article storage system further comprising:
a conveyance controller for conveying the article between the article accommodating section and the carry in/out port by directly controlling the driving device of the article conveying apparatus; and
a communication device for communicating at least control information executed by the driving device from the conveyance controller, between the driving device and the conveyance controller.

2. The article storage system as claimed in claim 1, wherein the article conveying apparatus includes a remote input/output device for performing transmission and reception of input/output information with the conveyance controller through the communication device.

3. The article storage system as claimed in claim 1, wherein
the article conveying apparatus comprises a fork device for performing transfer of the article between the article conveying apparatus and the article accommodating section, and a carriage for lifting and lowering the fork device, and
the driving device comprises a travel driving device for traveling the article conveying apparatus, a lift driving device for lifting and lowering the carriage, and a take in/out driving device for driving the fork device.

4. The article storage system as claimed in claim 3, wherein
the article conveying apparatus comprises a travel position detection device for detecting a travel position of the article conveying apparatus, and
the conveyance controller drives the travel driving device based on the travel position detected by the travel position detection device to control a movement position of the article conveying apparatus.

5. The article storage system as claimed in claim 3, wherein
the article conveying apparatus includes a lift position detection device for detecting a lifted/lowered position of the carriage, and
the conveyance controller inputs the lifted/lowered position detected by the lift position detection device via the communication device, and drives the lift driving device based on the lifting/lowering position to control a movement position of the carriage.
